(19) United States
(12) Patent Application Publication
(10) Pub. No.: US 2022/0105674 A1
(43) Pub. Date: Apr. 7, 2022

(54) METHOD FOR PRODUCING ELASTOMERIC MOLDED BODIES

(71) Applicant: Carl Freudenberg KG, Weinheim (DE)

(72) Inventors: Jan Kuiken, Weinheim (DE); Boris Traber, Hirschberg (DE); Ernst Osen, Birkenau (DE)

(21) Appl. No.: 17/428,285

(22) PCT Filed: Dec. 13, 2019
(86) PCT No.: PCT/EP2019/085043

§ 371 Date: Aug. 4, 2021

(30) Foreign Application Priority Data
Feb. 5, 2019 (DE) 10 2019 102 758.6

(51) Int. Cl. B29C 64/112; B29C 64/245; B29C 64/295; B29C 64/209; B29D 99/00

(52) U.S. Cl. CPC B29C 64/112; B29C 64/245; B33Y 10/00; B29C 64/209; B29D 99/0053; B29C 64/295

(57) ABSTRACT

The invention relates to a method for producing elastomeric molded bodies, comprising the following steps: a) providing an elastomer raw material that can be crosslinked by heat and contains at least 10 wt. % of fillers; b) conveying raw material in steps into a manufacturing zone (1); c) shaping in steps a section of the molded body from the raw material; d) crosslinking in steps the section molded from the raw material by supplying heat; e) repeating steps b) to d) until the molded body is completed.

### CROSS-REFERENCE TO PRIOR APPLICATIONS

This application is a U.S. National Phase application under 35 U.S.C. § 371 of International Application No. PCT/EP2019/085043, filed on Dec. 13, 2019, and claims benefit to German Patent Application No. DE 10 2019 102 758.6, filed on Feb. 5, 2019. The International Application was published in German on Aug. 13, 2020 as WO 2020/160820 under PCT Article 21(2).

### FIELD

The invention relates to a method for producing elastomeric molded bodies by means of a generative manufacturing process.

### BACKGROUND

Such a method is known from WO 2018/072809 A1. In the previously known method, elastomeric molded bodies are produced from a silicone material. Via a spatially independently controllable 3D printing device, the application of raw material in the form of drops or continuous strands by means of a printing nozzle onto a spatially independently controllable support plate takes place in an X-Y working plane. This gradually results in the molded body on the support plate. The silicone material is crosslinked by introducing electromagnetic radiation. In this method, it is disadvantageous that not every elastomeric material can be crosslinked by introducing electromagnetic radiation. In particular, elastomeric materials used in sealing technology are crosslinked at least by supplying heat.

Elastomers which crosslink by means of UV light are also known from the prior art. However, such a system is disadvantageous in that the raw material must be transparent. Highly filled mineral materials and carbon black-filled mixtures are ruled out due to a lack of UV adsorption.

### SUMMARY

In an embodiment, the present invention provides a method for producing an elastomeric molded body, comprising: a) providing a heat-crosslinkable elastomer raw material containing at least 10 wt. % fillers; b) conveying in steps the raw material into a manufacturing zone; c) shaping in steps a section of the molded body from the raw material as a shaped section; d) crosslinking in steps the shaped section by supplying heat; and e) repeating steps b) to d) until the molded body is completed.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a device for carrying out the method with a heatable nozzle;

FIG. 2 a device with a grid-shaped manufacturing zone;

FIG. 3 a device for processing flat raw material;

FIG. 4 the pressing of the flat raw material into the chambers of the manufacturing zone;

FIG. 5 a device for introducing raw material into the chambers of the manufacturing zone.

### DETAILED DESCRIPTION

In an embodiment, the present invention provides a method for producing elastomeric molded bodies, which, on the basis of customary elastomeric materials, enables the production of molded bodies used in sealing technology.

The method according to the invention for producing elastomeric molded bodies comprises the following steps:

Providing a heat-crosslinkable elastomer raw material containing at least 10 wt. % fillers

Conveying in steps the raw material into a manufacturing zone

Shaping in steps a section of the molded body from the raw material

Crosslinking in steps the section brought into shape from the raw material by supplying heat

Repeating the steps of conveying, shaping, crosslinking, and supplying heat until the molded body is completed.

The method according to the invention for producing elastomeric molded bodies is a generative manufacturing process in which the molded body is produced in steps from the raw material. In doing so, the raw material is introduced and molded, and the raw material is crosslinked in such a way that the molded body is gradually produced. In this respect, the method according to the invention is a rapid prototyping method and comparable to a 3D printing method.

In the classical shaping method of elastomeric molded bodies, the raw material is placed into a mold and exposed to an elevated pressure and elevated temperature. In such a method, the raw material is crosslinked in a temperature range of about 170° C. to 190° C. Sufficient crosslinking can be achieved only if low-molecular-weight polymers are used. However, decisive for vulcanization or crosslinking is not the temperature but the amount of heat which acts on the raw material per unit of time. If a specific amount of heat is exceeded, a crosslinking reaction is initiated, which propagates through the raw material in a diffusion-controlled manner. This is in particular true for raw materials with peroxidic crosslinking. However, in other crosslinking systems, such as in sulfur crosslinking, bisphenolic crosslinking, or aminic crosslinking, the rule applies that the crosslinking reaction proceeds more rapidly at higher temperatures. In principle, with an increase in temperature by 10 Kelvin, doubling to quadrupling of the reaction rate of the crosslinking takes place.

In the method according to the invention, the raw material is preferably brought only very briefly to an elevated temperature in the range of 200° C. to 500° C. Disadvantageous material changes of the raw material or of the shaped and completely crosslinked elastomer material can thereby be avoided. Disadvantageous effects are, in particular, not to be expected if the raw material is exposed at most for a period of up to 50 seconds.

The input of the amount of heat also depends on the component dimension. The high-temperature vulcanization according to the invention is in particular suitable for thinner components with a wall thickness of less than 6 mm. With greater wall thicknesses, the skin effect becomes disadvantageously noticeable. With this effect, the gradient of the amount of heat introduced in relation to the wall thickness of the molded body results in stronger crosslinking in the outer wall sections. This can lead to outer regions being overcrosslinked and inner regions being undercrosslinked. In the method according to the invention, the material is therefore applied such that the structures to be crosslinked in sections have wall thicknesses of less than 2 mm.

The method according to the invention enables in particular the use of elastomeric materials customary in elastomeric molded bodies. In particular, materials used in sealing technology for producing dynamic or static seals also come into consideration. The elastomeric materials may also contain a high proportion of filler, such as carbon black or silicic acid. The proportion of the fillers is at least 10 wt. %. However, the proportion may also be significantly higher and be, for example, 30 wt. %. Such materials are opaque and therefore not crosslinkable by UV crosslinking, for example.

Advantageous usage properties of the elastomeric molded body result if the Shore hardness of the molded body is between 30 and 90 Shore A.

Elastomer raw materials known from sealing technology are in particular suitable as elastomer raw materials. In this respect, the elastomer raw material can be a rubber material, such as NR, NBR, BR, IR, EPDM, CR, IIR, or FKM.

Furthermore, high-molecular-weight polymers can also be processed using the method according to the invention. These materials are in particular advantageous in comparison to low-molecular-weight polymers used in the previously known rapid prototyping or 3D printing methods. Low-molecular-weight polymers have the disadvantage of low mechanical strength, which, however, is in particular relevant to molded bodies that function as a sealing element. Therefore, molded bodies produced, for example, in the rapid prototyping method have previously been used exclusively for the production of prototypes and for serial use. In contrast, by using the high-molecular-weight polymers described above and/or using a high proportion of fillers, functional elastic molded bodies suitable for serial use can be produced.

Disadvantageous effects on the raw material can in particular also be avoided if the raw material is processed in an oxygen-free environment. For this purpose, the raw material can be processed in a vacuum. Alternatively, the raw material can also be processed in an inert gas atmosphere.

The raw material is preferably brought to a temperature of 200° C. to 400° C. It has been found that the raw material crosslinks sufficiently quickly in this temperature range so that an elastomeric molded body can be produced in the manner of a 3D printing method. At the same time, however, the influence of heat is so low that no adverse effects with respect to the material quality can be expected. A particularly preferred temperature range is between 220° C. and 300° C.

The manufacturing zone onto which the raw material is deposited can be spatially movable. For this purpose, the manufacturing zone can have a spatially movable table onto which the raw material is deposited. The elastomeric molded body is produced by depositing the raw material on the table-like manufacturing zone, which simultaneously moves spatially. The three-dimensional molded body is produced by changing the position of the manufacturing zone. According to an alternative embodiment, the conveying device which conveys the raw material into the manufacturing zone can be moved spatially. In this case, it is decisive that the conveying device and the manufacturing zone can move relative to one another in the horizontal and vertical directions so that a three-dimensional molded body can be produced.

The raw material is preferably deposited on the manufacturing zone dropwise or in the shape of a continuous strand. The dropwise or strand-shaped deposition of the raw material and the simultaneous spatial movement of the manufacturing zone continuously produces the elastic molded body. In this case, the drop size or the strand diameter is selected in such a way that fine structures can also be produced.

The raw material is preferably heated during depositing and thereby crosslinked. This simultaneously results in the shaping of the molded body and local crosslinking of the raw material. As a result, subsequent heat treatment of the entire molded body can be omitted. Local crosslinking of the raw material takes place analogously to the shaping.

The elastomer material can be pressed through a nozzle for shaping, wherein the nozzle is assigned a heating element which heats the raw material during depositing. As a result, the raw material is crosslinked directly with the discharge of the raw material from the nozzle.

The raw material can be conveyed to the nozzle by means of a conveying screw. A tempering of the raw material can also take place in the region of the conveying screw so that the viscosity of the raw material decreases. However, the tempering must be carried out in such a way that no unintentional vulcanization of the raw material occurs.

According to an alternative embodiment, the manufacturing zone can be grid-shaped and comprise a plurality of chambers into which the raw material is deposited, wherein the manufacturing zone can be moved so that the molded body is formed in layers. In this embodiment, the manufacturing zone has a plurality of chambers arranged next to one another. These may, for example, be arranged like a matrix. In order to form the molded body, raw material is filled into the chambers, wherein only predetermined chambers are filled. Only those chambers to which a material section of the molded body is assigned are filled. The remaining chambers remain empty. In this case, it is in particular advantageous that the formation of the three-dimensional structure in layers per volume element results in an increased processing speed.

In this embodiment, the manufacturing zone is preferably heated in order to bring about the shaping and the crosslinking of the raw material. For this purpose, a heating element can be placed onto the manufacturing zone in order to crosslink the raw material. As soon as crosslinking of the raw material in the chambers is initiated, the manufacturing zone is preferably moved horizontally and the raw material, which has undergone shaping in the chambers, is discharged. New raw material is subsequently filled into the chambers and integrally bonds with the raw material vulcanized in the previous work step. In this case, it is advantageous that the raw material can be pressed with a contact pressure onto the underlying layer so that the raw material comes into contact with the entire surface of the layer.

The raw material can be introduced into the chambers of the manufacturing zone by means of a nozzle. In this case, the manufacturing zone can be moved in such a way that the chambers to be filled can be moved in the direction of the nozzle.

According to an alternative embodiment, the raw material can be designed to be flat and can be pressed into the chambers of the manufacturing zone in the shape of a distribution channel. In this embodiment, the raw material is introduced into the chambers by a scraper method analogously to the screen printing method. The raw material is placed onto the manufacturing zone and subsequently pressed into the chambers by means of a suitable tool, wherein the remaining raw material is removed from the manufacturing zone, for example scraped off.

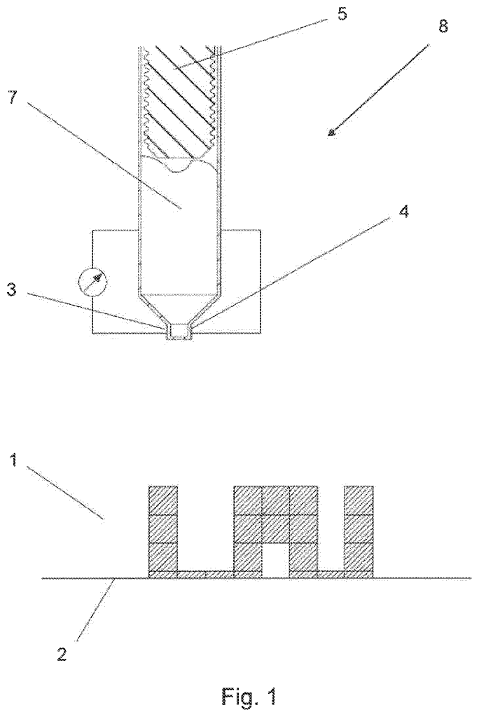

FIG. 1 shows a device 8 for carrying out the method for producing elastomeric molded bodies. The device 8 substantially corresponds to an injection-molding machine. The device 8 has a storage container 7 for receiving the elastomer raw material. The raw material passes into the region of the nozzle 3 via a conveying screw 5, wherein drops of the raw material from the nozzle 3 are conveyed in the direction of the manufacturing zone 1 in order to produce the molded body. The manufacturing zone 1 comprises a table 2 which can be moved both horizontally and vertically. The drops conveyed through the nozzle 3 are placed onto the table 2, wherein the position of the table 2 changes so that the molded body is gradually produced from the deposited drops.

The nozzle 3 is assigned a heating element 4 which heats up the raw material during depositing. The crosslinking reaction is triggered by the heating so that the drop of raw material is crosslinked after deposition onto the table 2.

The heating element 4 is a composite body and consists of an insulating element made of ceramic to which a heating element in the shape of a resistance heater is assigned. According to an alternative embodiment, the insulating element can be formed from a high-temperature thermoplastic. In the present embodiment, the heating element is a wall-shaped element made of spring steel, which is connected to a power source. The material has a high electrical resistance so that it rapidly heats up when an electrical voltage is applied, for example a voltage of 24 volts and an electrical current of 600 amperes. As a result, a high amount of heat is provided and introduced into the raw material in a very short time. The amount of heat is dimensioned in such a way that the raw material is brought to a temperature of 280° C. At this temperature, the vulcanization process of the drop raw material is initiated within a very short time, and no adverse effects on the material properties can be expected since the temperature input only occurs for a very short time.

The table 2 is designed in such a way that it can move in such a way that a counter-pressure opposes the nozzle 3 or the drop exiting the nozzle 3. This makes it possible to deposit the raw material in a targeted manner.

According to an alternative embodiment, a second conveying unit is provided, which conveys a supporting material, for example a UV-curing acrylate having a weak crosslinking density, into the manufacturing zone 1. The supporting material hardens quickly and supports the raw material, which is in particular advantageous in the construction of complex 3D molded parts. The supporting material is then released from the molded body. This makes it possible to produce molded bodies with undercuts and roundings.

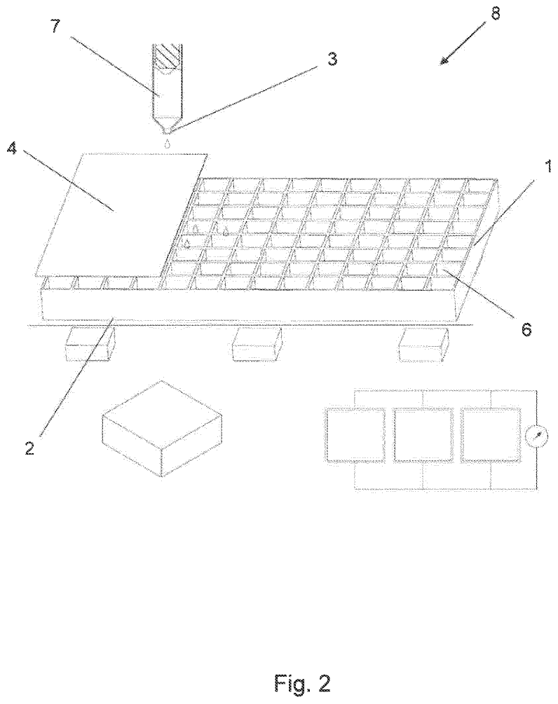

FIG. 2 shows an alternative device 8 for carrying out the method for producing elastomeric molded bodies. The device 8 according to FIG. 2 also comprises a storage container 7 and a conveying screw 5, which conveys the raw material in the direction of a nozzle 3, from which the raw material arrives in the manufacturing zone 1. The manufacturing zone 1 also comprises a table 2, which can be moved both vertically and horizontally. Alternatively, it is also conceivable for the conveying screw 5 to be movable in the vertical and/or the horizontal direction. In this embodiment, the table 2 is grid-shaped and has a plurality of chambers 6 into which the raw material can be deposited. In order to produce the molded body, raw material is filled into the chambers 6, the region of which corresponds to the region of the later molded body. Other chambers 6 remain empty. After filling the raw material into the chambers 6, a flat heating element 4 in the shape of an electrical resistance heater is placed onto the table 2, wherein the heating element 4 covers the chambers 6. An electrical voltage is then applied to the heating element 4 and the raw material located in the chambers 6 is heated to a temperature of 280° C. This triggers the vulcanization process. The heating element 4 is subsequently removed again and the table 2 is moved in the vertical direction so that the now crosslinked elements are discharged from the chambers 6 on the side facing away from the nozzle 3. The chambers 6 are subsequently refilled with raw material. This gradually produces the molded body in a layer-by-layer process.

According to an alternative embodiment, a further heating element 4 can also be integrated in the chamber 6. The heating process then takes place directly within the chamber 6 through the further heating element 4 integrated into the chamber 6. In addition, a flat heating element 4 in the shape of an electrical resistance heater can be provided, which is placed onto the table 2 and covers the chambers 6. In this case, the heating element 4 can also be used without being heated only for generating pressure. The electrical voltage control can be carried out by electrical wires in the matrix structure, which wires can be vapor-deposited or printed, for example.

The table 2 with the chambers 6 preferably consists of a pressure-resistant and incompressible material such as ceramic. Alternatively, high-temperature-stable thermoplastics can also be used.

According to an alternative embodiment, the chambers 6 are each equipped with a heating element 4 in the shape of a metallic electrical resistance heater. For this purpose, the walls of the chambers 6 are coated with metallic material.

If, during the heating process, the table 2 moves a small distance in the vertical direction, in the direction of the nozzle 3, the raw material drops located in the chambers 6 can flow into one another so that a dense structure is achieved.

Alternatively, it is also possible to introduce a supporting material into chambers 6, the position of which does not correspond to the later molded body, which in turn makes it possible to create complex geometries.

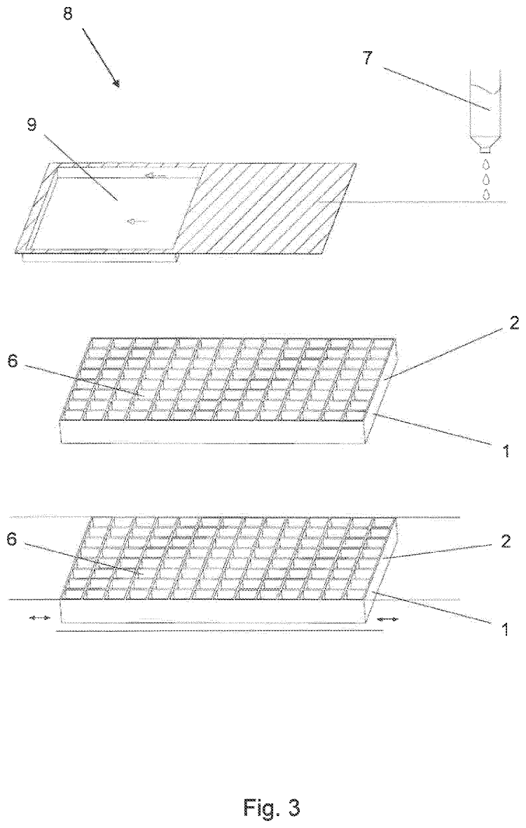

FIG. 3 shows a development of the method shown in FIG. 2. In the device 8 used for this purpose, the raw material is deposited flat onto the table 2 provided with chambers 6 by means of a slot nozzle. With a press plate 9, the raw material is pressed into the chambers 6. In doing so, the chambers 6 into which no raw material is to enter are closed beforehand.

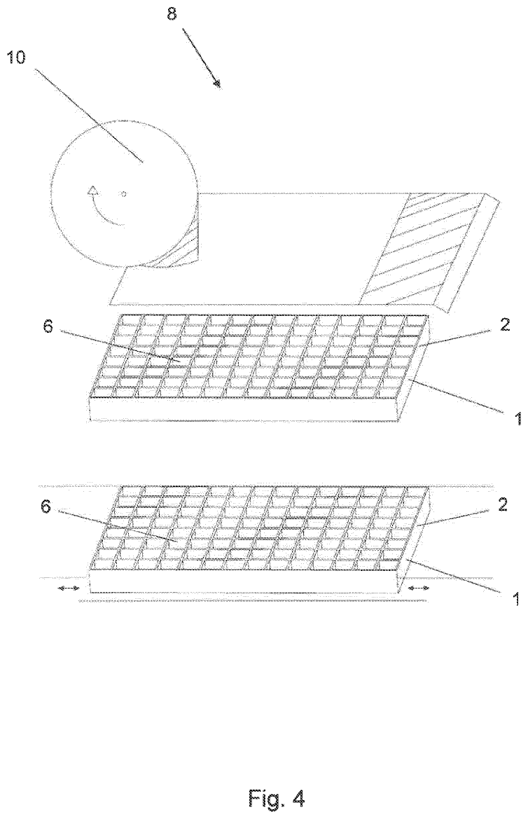

FIG. 4 shows an alternative embodiment of the device 8 according to FIG. 3, in which the flat, thin raw material is conveyed through a slot nozzle and pressed into the chambers 6 by means of a roller 10. Alternatively, a scraper can also be used.

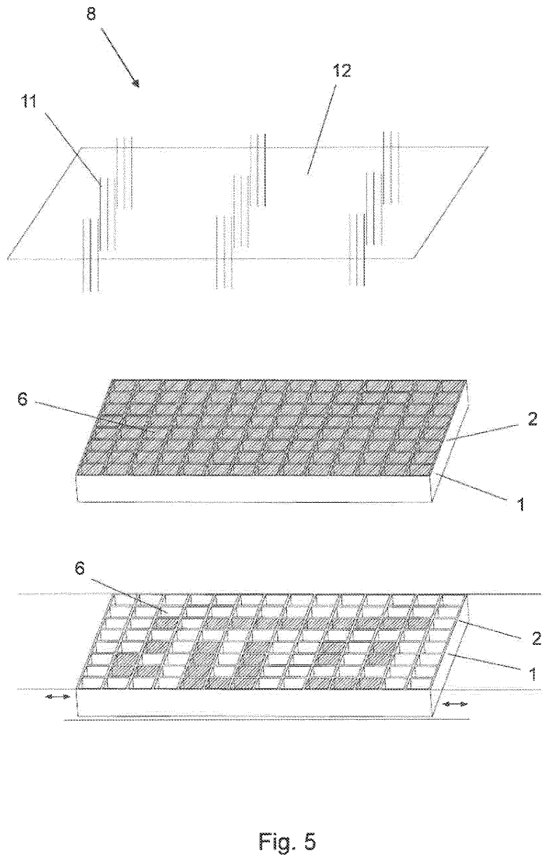

FIG. 5 shows an embodiment of the device 8 according to FIG. 3 or 4. In the present device 8, a flat raw material is placed onto the grid-like table 2. A switch board 11 with controllable needles 12 is subsequently guided in the direction of the table 2, wherein needles 12 protrude from the switch board 11 at the points where the raw material is to be pressed into chambers 6. At the remaining points, the needles 12 do not protrude from the switch board 11. If the switch board 11 moves toward the table 2, the protruding needles 12 push the raw material into the chambers 6. In the remaining regions, the raw material remains above the table 2 and can subsequently be removed from the table 2 by scraping or the like. The raw material is subsequently heated by means of heating elements 4 integrated into the chamber 6 or by means of a flat heating element 4 placed thereon.

In all devices 8 shown in the figures, the raw material in the manufacturing zone 1 is processed in an inert nitrogen atmosphere. Thermooxidative aging of the raw material can thereby be prevented.

The method according to the invention in the devices 8 described above is suitable for processing standard elastomer materials which are common in the field of sealing technology. Such materials are, for example, nitrile butadiene rubber (NBR) and the like. The elastomer materials which form the raw material can also be provided with filler, for example with carbon black. It is not necessary to use particularly flowable, low-viscosity elastomer types. It is in particular possible to use sealing materials and to produce molded bodies that function as a sealing element or have sealing elements.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for producing an elastomeric molded body, comprising:
a) providing a heat-crosslinkable elastomer raw material containing at least 10 wt. % fillers;
b) conveying in steps the raw material into a manufacturing zone;
c) shaping in steps a section of the molded body from the raw material as a shaped section;
d) crosslinking in steps the shaped section by supplying heat; and
e) repeating steps b) to d) until the molded body is completed.

2. The method of claim 1, wherein the fillers comprise carbon black and/or silicic acid.

3. The method of claim 1, wherein the elastomer raw material is opaque.

4. The method of claim 1, wherein the manufacturing zone is spatially movable.

5. The method of claim 1, wherein the raw material is deposited dropwise or in a shape of a continuous strand onto the manufacturing zone.

6. The method of claim 5, wherein the raw material is heated during depositing and thereby crosslinked.

7. The method of claim 5, wherein the shaping comprises pressing the raw material through a nozzle, and
wherein the nozzle is assigned a heating element which heats up the raw material during depositing.

8. The method of claim 7, wherein the raw material is conveyed to the nozzle by a conveying screw.

9. The method of claim 1, wherein the manufacturing zone is grid-shaped and has a plurality of chambers into which the raw material is deposited, and
wherein the manufacturing zone is movable so that the molded body is formed in layers.

10. The method of claim 9, wherein the manufacturing zone is heated for crosslinking.

11. The method of claim 9, wherein for crosslinking, a heating element is placed onto the manufacturing zone.

12. The method of claim 9, wherein the raw material is introduced into the grid-shaped manufacturing zone by a nozzle.

13. The method of claim 9, wherein the raw material is introduced into the grid-shaped manufacturing zone by pushing in a raw material applied flatly to the manufacturing zone.
